(19) United States
(12) Patent Application Publication
(10) Pub. No.: US 2004/0049426 A1
(43) Pub. Date: Mar. 11, 2004

(54) Ticketing POS terminal

(76) Inventor: Yasunori Miyagawa, Kawasaki-shi (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/645,568

(22) Filed: Aug. 22, 2003

(30) Foreign Application Priority Data
Aug. 22, 2002 (JP) 241644/2002

(51) Int. Cl. G06F 17/60

(52) U.S. Cl. 705/16

(57) ABSTRACT

In a ticketing POS terminal which includes a ticket printer for printing and issuing a plurality of kinds of tickets and a customer display section (30) equipped with an input touch panel, the customer display section displays, on the input touch panel, a list (31) of the tickets to be issued by the ticket printer. The ticket printer prints and issues desired tickets selected by a customer when the customer selectively touches parts of the list where the desired tickets are displayed on the input touch panel. The customer display section further displays, on the input touch panel, a content (two tickets for ABC Aquarium or one ticket for XYZ Zoo) and a price (¥10,000 or ¥1,000) of each of the tickets selected by the customer and a total ticket purchase price (¥11,000 in 35) of the tickets selected by the customer.

This application claims priority to prior Japanese patent application JP 2002-241644, the disclosure of which is incorporated herein by reference.

### BACKGROUND OF THE INVENTION

This invention relates to a POS terminal.

In recent years, various kinds of tickets are sold in a store, such as a convenience store, by the use of a POS (point of sales) terminal. In such ticket sales, a ticket list of a wide variety of available tickets is separately prepared independently of the POS terminal. This results in following problems.

As a first problem, it is necessary to separately prepare the ticket list of a wide variety of available tickets and to distribute the list to each store. In addition, the available tickets are changed from time to time every time. When the available tickets are changed, a new list must be prepared and distributed.

As a second problem, when a customer purchases a ticket, it is necessary for an operator to check the ticket list and to confirm the ticket desired by the customer. This is troublesome and time-consuming because a wide variety of tickets are available.

### SUMMARY OF THE INVENTION

It is therefore an object of this invention to provide a ticketing POS terminal which is capable of displaying a list of a plurality of tickets to be issued by a ticket printer, the content and the price of each of tickets selected by a customer, and the total price of the tickets selected by the customer.

According to this invention, there is provided a ticketing POS terminal comprising a ticket printer for printing and issuing a plurality of kinds of tickets and a customer display section equipped with an input touch panel, the customer display section displaying, on the input touch panel, a list of the tickets to be issued by the ticket printer, the ticket printer printing and issuing a desired ticket selected by a customer when the customer selectively touches a part of the list where the desired ticket is displayed on the input touch panel, the customer display section further displaying, on the input touch panel, a content and a price of the ticket selected by the customer and a total ticket purchase price.

According to this invention, there is also provided a ticketing POS terminal comprising a ticket printer for printing and issuing a plurality of kinds of tickets and a customer display section equipped with an input touch panel, the customer display section displaying, on the input touch panel, a purchase enter key and a list of the tickets to be issued by the ticket printer, the ticket printer printing and issuing a desired ticket selected by a customer when the customer selectively touches a part of the list where the desired ticket is displayed on the input touch panel and subsequently when the customer touches the purchase enter key, the customer display section further displaying, on the input touch panel, a content and a price of the ticket selected by the customer and a total ticket purchase price.

According to this invention, there is also provided a ticketing POS terminal comprising a ticket printer for printing and issuing a plurality of kinds of tickets and a customer display section equipped with an input touch panel, the customer display section displaying, on the input touch panel, a list of the tickets to be issued by the ticket printer, the ticket printer printing and issuing desired tickets selected by a customer when the customer selectively touches parts of the list where the desired tickets are displayed on the input touch panel, the customer display section further displaying, on the input touch panel, a content and a price of each of the tickets selected by the customer and a total ticket purchase price of the tickets selected by the customer.

According to this invention, there is also provided a ticketing POS terminal comprising a ticket printer for printing and issuing a plurality of kinds of tickets and a customer display section equipped with an input touch panel, the customer display section displaying, on the input touch panel, a purchase enter key and a list of the tickets to be issued by the ticket printer, the ticket printer printing and issuing desired tickets selected by a customer when the customer selectively touches parts of the list where the desired tickets are displayed on the input touch panel and subsequently when the customer touches the purchase enter key, the customer display section further displaying, on the input touch panel, a content and a price of each of the tickets selected by the customer and a total ticket purchase price of the tickets selected by the customer.

Japanese Unexamined Patent Publication No. H9-27079 discloses a POS terminal with a customer side display section to be operated by a customer. However, the above-mentioned publication does not disclose that the customer display section displays a list of a plurality of available tickets to be issued by the ticket printer and that the customer display section displays the content and the price of each of the tickets selected by the customer and the total ticket purchase price of the tickets selected by the customer.

### BRIEF DESCRIPTION OF THE DRAWINGS

FIG. 1 is a perspective view of a ticketing POS terminal according to one embodiment of this invention; and

FIG. 2 is a view for describing a touch panel equipped customer display section in the ticketing POS terminal illustrated in FIG. 1.

### DESCRIPTION OF THE PREFERRED EMBODIMENT

Now, description will be made of an embodiment of this invention with reference to the drawing.

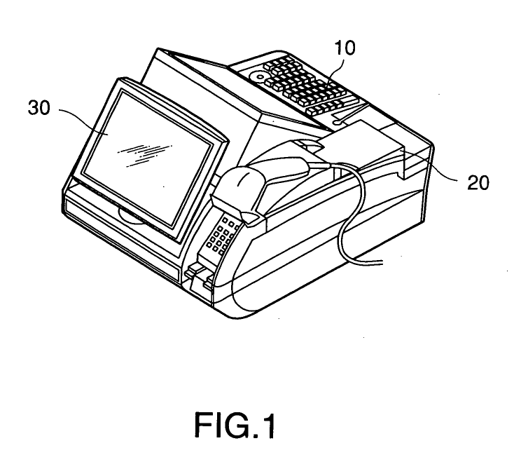

Referring to FIG. 1, a ticketing POS terminal 10 according to one embodiment of this invention comprises a ticket printer 20 for printing and issuing a plurality of kinds of tickets and a touch panel equipped customer display section 30 equipped with an input touch panel. The touch panel equipped customer display section 30 is positioned on a customer side of the ticketing POS terminal 10 to be operated by a customer.

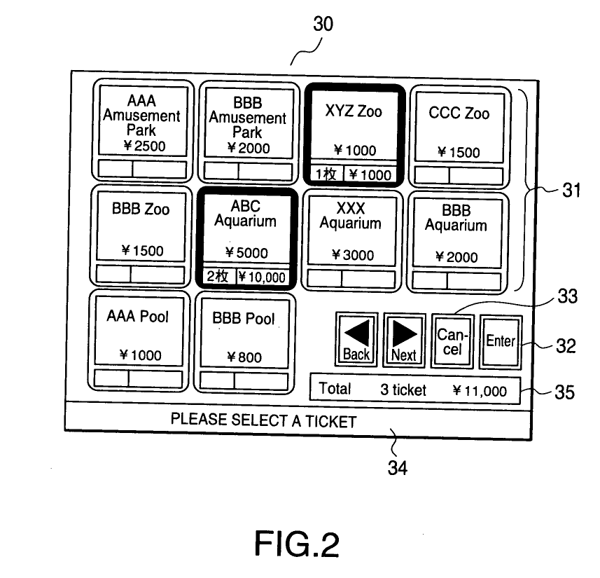

Referring to FIG. 2, the touch panel equipped customer display section 30 displays a list 31 of a plurality of kinds of tickets to be issued by the ticket printer 20 in FIG. 1 and a purchase enter key 32.

Referring to FIGS. 1 and 2, the ticketing POS terminal is operated as follows. A customer selectively touches a desired part of the list 31 where a desired ticket to be purchased is displayed. In this event, the customer selects the desired ticket N (N being an integer greater than 1) times by touching N times the desired part of the list 31 where the desired ticket to be purchased is displayed. Next, the customer touches the purchase enter key 32. In response, the desired ticket selected by the customer is printed and issued by the ticket printer 20. The touch panel equipped customer display section 30 displays the contents (in the illustrated example, two tickets for ABC Aquarium and one ticket for XYZ Zoo) and the prices (in the illustrated example, ¥10,000 and ¥1,000) of the respective tickets selected by the customer. In addition, the total number (in the illustrated example, three) of the tickets selected by the customer and the total price (in the illustrated example, ¥11,000) are displayed at a part 35 in FIG. 2.

The touch panel equipped customer display section 30 further displays a purchase cancel key 33. If the purchase cancel key 33 is touched before the purchase enter key 32 is touched, the purchase of the tickets selected by the customer is cancelled.

The touch panel equipped customer display section 30 further displays a message “PLEASE SELECT A TICKET” as a guidance message 34 to the customer.

Thus, according to this invention, the POS terminal 10 with the ticket printer 20 for issuing a concert ticket, an amusement park ticket, and so on has the customer display section equipped with the touch panel. The touch panel equipped customer display section 30 displays the list including a variety of tickets and the customer is invited to select a desired ticket. Thus, vending or purchasing operation is efficiently carried out.

Next, operation of this embodiment will be described.

In FIG. 1, the customer display section 30 of the ticketing POS terminal displays the message (34 in FIG. 2) inviting the customer to select a ticket. The customer selects a desired ticket from a variety of tickets (31 in FIG. 2) displayed on the touch panel equipped customer display section 30 by touching a corresponding part of the touch panel. The customer selects the desired ticket N (N being an integer greater than 1) times by touching the corresponding part of the touch panel N times. The number of tickets and the price for each item are displayed at the corresponding part of the list 31.

Such selection is repeated until all of the desired tickets are selected. Every time when any desired ticket is selected on the touch panel, the number of tickets to be purchased and the total price of the tickets are displayed at the part 35 of the touch panel equipped customer display section 30 in addition to the number of tickets and the price for each item being displayed at the corresponding part of the list 31. Thus, the customer can immediately confirm the contents to be purchased.

In order to correct any selected ticket, the customer pushes the purchase cancel key (33 in FIG. 2) displayed on the touch panel equipped customer display section 30 to invalidate the selected ticket. Thus, cancellation is executed.

When the selection of the tickets is finished, the customer presses the purchase enter key (32 in FIG. 2) of the touch panel equipped customer display section 30. Then, the purchased tickets are printed out by the ticket printer 20.

In the ticketing POS terminal, the customer selects and purchases the tickets via a series of steps mentioned above.

The above-mentioned system may be modified by replacing the built-in ticket printer by an external ticket printer. With this structure also, similar transaction can be carried out.

As described above, according to this invention, the ticketing POS terminal is realized which displays a list of a plurality of available tickets to be issued by the ticket printer, the content and the price of each of the tickets selected by a customer, and the total price of the tickets selected by the customer.

According to this invention, it is unnecessary to separately prepare and distribute the list of a number of available tickets.

According to this invention, it is unnecessary for the operator to confirm each ticket desired by the customer by the use of the list of a variety of available tickets when the customer purchases the ticket.

Reviewing FIGS. 1 and 2, a ticketing POS terminal 10 includes a ticket printer 20 for printing and issuing a plurality of kinds of tickets and a customer display section 30 equipped with an input touch panel. The customer display section 30 displays, on the input touch panel, a list 31 of the tickets to be issued by the ticket printer 20. The ticket printer 20 prints and issues desired tickets selected by a customer when the customer selectively touches parts of the list 31 where the desired tickets are displayed on the input touch panel. The customer display section 30 further displays, on the input touch panel, a content (two tickets for ABC Aquarium or one ticket for XYZ Zoo) and a price (¥10,000 or ¥1,000) of each of the tickets selected by the customer and a total ticket purchase price (¥11,000 in 35) of the tickets selected by the customer.

The customer display section 30 further displays, on the input touch panel, a guidance message (“PLEASE SELECT A TICKET” in 34) for the customer.

The customer display section 30 also displays, on the input touch panel, a purchase enter key 32. In this event, the ticket printer 20 prints and issues the desired tickets selected by the customer when the customer selectively touches parts of the list 31 where the desired tickets are displayed on the input touch panel and subsequently when the customer touches the purchase enter key 32.

The customer display section 30 further displays, on the input touch panel, a purchase cancel key 33 so that, when the purchase cancel key 33 is touched before the purchase enter key 32 is touched, purchase of the tickets selected by the customer is cancelled.

In the ticketing POS terminal 10, the ticket printer 20 may print and issue a desired ticket selected by the customer when the customer selectively touches a part of the list 31 where the desired ticket is displayed on the input touch panel. In this case, the customer display section 30 may display, on the input touch panel, a content (one ticket for XYZ Zoo) and a price (¥1,000) of the ticket selected by the customer and a total ticket purchase price (¥1,000 in 35).

In this event, the ticket printer 20 may print and issue the desired ticket selected by the customer when the customer selectively touches a part of the list 31 where the desired ticket is displayed on the input touch panel and subsequently when the customer touches the purchase enter key 32.

Purchase of the ticket selected by the customer may be cancelled when the purchase cancel key 33 is touched before the purchase enter key 32 is touched.

What is claimed is:

1. A ticketing POS terminal comprising a ticket printer for printing and issuing a plurality of kinds of tickets and a customer display section equipped with an input touch panel, the customer display section displaying, on said input touch panel, a list of the tickets to be issued by the ticket printer, the ticket printer printing and issuing a desired ticket selected by a customer when the customer selectively touches a part of the list where the desired ticket is displayed on said input touch panel, the customer display section further displaying, on said input touch panel, a content and a price of the ticket selected by the customer and a total ticket purchase price.

2. A ticketing POS terminal as claimed in claim 1, wherein the customer display section further displays, on said input touch panel, a guidance message for the customer.

3. A ticketing POS terminal comprising a ticket printer for printing and issuing a plurality of kinds of tickets and a customer display section equipped with an input touch panel, the customer display section displaying, on said input touch panel, a purchase enter key and a list of the tickets to be issued by the ticket printer, the ticket printer printing and issuing a desired ticket selected by a customer when the customer selectively touches a part of the list where the desired ticket is displayed on said input touch panel and subsequently when the customer touches the purchase enter key, the customer display section further displaying, on said input touch panel, a content and a price of the ticket selected by the customer and a total ticket purchase price.

4. A ticketing POS terminal as claimed in claim 3, wherein the customer display section further displays, on said input touch panel, a purchase cancel key so that, when the purchase cancel key is touched before the purchase enter key is touched, purchase of the ticket selected by the customer is cancelled.

5. A ticketing POS terminal as claimed in claim 3, wherein the customer display section further displays, on said input touch panel, a guidance message for the customer.

6. A ticketing POS terminal as claimed in claim 5, wherein the customer display section displays a message “PLEASE SELECT A TICKET” as the guidance message.

7. A ticketing POS terminal comprising a ticket printer for printing and issuing a plurality of kinds of tickets and a customer display section equipped with an input touch panel, the customer display section displaying, on said input touch panel, a list of the tickets to be issued by the ticket printer, the ticket printer printing and issuing desired tickets selected by a customer when the customer selectively touches parts of the list where the desired tickets are displayed on said input touch panel, the customer display section further displaying, on said input touch panel, a content and a price of each of the tickets selected by the customer and a total ticket purchase price of the tickets selected by the customer.

8. A ticketing POS terminal as claimed in claim 7, wherein the customer display section further displays, on said input touch panel, a guidance message for the customer.

9. A ticketing POS terminal comprising a ticket printer for printing and issuing a plurality of kinds of tickets and a customer display section equipped with an input touch panel, the customer display section displaying, on said input touch panel, a purchase enter key and a list of the tickets to be issued by the ticket printer, the ticket printer printing and issuing desired tickets selected by a customer when the customer selectively touches parts of the list where the desired tickets are displayed on said input touch panel and subsequently when the customer touches the purchase enter key, the customer display section further displaying, on said input touch panel, a content and a price of each of the tickets selected by the customer and a total ticket purchase price of the tickets selected by the customer.

10. A ticketing POS terminal as claimed in claim 9, wherein the customer display section further displays, on said input touch panel, a purchase cancel key so that, when the purchase cancel key is touched before the purchase enter key is touched, purchase of the tickets selected by the customer is cancelled.

11. A ticketing POS terminal as claimed in claim 9, wherein the customer display section further displays, on said input touch panel, a guidance message for the customer.

12. A ticketing POS terminal as claimed in claim 11, wherein the customer display section displays a message “PLEASE SELECT A TICKET” as the guidance message.
